(19) United States
(12) Patent Application Publication
(10) Pub. No.: US 2025/0242953 A1
(43) Pub. Date: Jul. 31, 2025

(54) SEALING DEVICE

(71) Applicant: Alcon Inc., Fribourg (CH)

(72) Inventors: Felix Brinckmann, Roßdorf (DE); Nils Schweizer, Bad König (DE)

(21) Appl. No.: 19/034,869

(22) Filed: Jan. 23, 2025

Related U.S. Application Data
(60) Provisional application No. 63/624,957, filed on Jan. 25, 2024.

(51) Int. Cl. B65B 7/16; B65B 11/52; B65B 25/00; B65B 51/14

(52) U.S. Cl. CPC B65B 7/164; B65B 11/52; B65B 25/008; B65B 51/14

(57) ABSTRACT

A sealing device for sealing a sealing foil onto a top surface of a primary packaging shell for a contact lens. The sealing device comprises a shell support and a sealing head comprising a contact surface facing downwardly. The sealing device comprises at least one linear actuator for performing a vertical relative movement of the shell support and the sealing head to press the sealing foil against the top surface of the primary packaging shell. The sealing device comprises a foil holder for holding the sealing foil in a vertical gap between the contact surface of the sealing head and the top surface of the primary packaging shell. The sealing foil is sealed to the top surface of the primary packaging shell when the shell support and the sealing head move towards each other.

### FIELD OF THE INVENTION

The present invention generally relates to the field of primary packaging of an ophthalmic article. More specifically, it is related to a sealing device and a method for sealing a sealing foil onto a top surface of a primary packaging shell for an ophthalmic article such as an ophthalmic lens, in particular a contact lens such as a soft contact lens.

### BACKGROUND OF THE INVENTION

Ophthalmic articles such as, for example, corneal onlays, eye wetting films and most importantly ophthalmic lenses, in particular contact lenses such as a soft contact lenses, are typically manufactured in large quantities in automated manufacturing processes in automated manufacturing lines. For the sake of simplicity, in the following it is referred to the automated manufacturing of ophthalmic lenses, in particular soft contact lenses which are manufactured in automated lens manufacturing lines. These lenses are inspected in an inspection station of the automated lens manufacturing line. After having successfully passed the inspection station, the lenses may subsequently get packaged in blister-like primary packages. Packaging of the lenses is typically performed in a primary packaging line which may also form part of the automated lens manufacturing line.

A typical primary package may comprise a primary packaging shell with a concave cavity into which the lens may be placed and into which a predetermined amount of a storage solution, e.g. saline, may then be dispensed. Thereafter, a sealing foil may be sealed onto a top surface of the primary packaging shell. To perform the various operations (placing the lens into the cavity, dispensing saline, sealing the foil to the top surface, etc.) at various stations of the primary packaging line, the primary packaging shells may be transported through these stations on shell carriers. Typically, one such shell carrier may concurrently transport a plurality of primary packing shells linearly arranged one after the other on the shell carrier.

At the sealing station, a plurality of sealing foils which are connected to one another to form a sealing foil strip may be sealed onto the top surfaces of the plurality of packaging shells to form a blister strip of primary packages. For that purpose, each sealing foil of the sealing foil strip may be thermally bonded (e.g. heat-sealed) to a respective sealing portion of the top surface of the respective primary packaging shell to seal the concave cavity of the respective primary packaging shell containing the lens and the saline.

A known sealing device suitable to perform the sealing operation comprises a heatable sealing head having a contact surface facing downwards to press the sealing foil against the sealing portion of the top surface of the primary packaging shell arranged on the shell carrier. When the shell carrier arrives at a position beneath the sealing head, the shell carrier with the primary packaging shells arranged thereon may be moved upwards until the sealing foil is pressed onto the top surface of the primary packaging shell by the contact surface of the heated sealing head, thereby sealing the sealing foil to the top surface of the primary packaging shell. Thereafter, the shell carrier is moved downwards again, and the shell carrier with the sealed primary packages arranged thereon is further transported through the primary packaging line.

In the afore-described primary packaging line, after the lens has been placed into the cavity and the saline has been dispensed into the cavity the sealing foil strip comprising the plurality of sealing foils connected to one another is loosely placed on the top surfaces of the primary packaging shells arranged on the shell carrier, prior to the shell carrier being transported to the position underneath the sealing head. As the cavities are filled with saline to a considerable extent, due to capillary forces saline may be drawn out of the concave cavity into the small gaps formed between the top surface of the primary packaging shell and the sealing foil loosely resting thereon, leading to spillage of saline on the top surface of the primary packaging shell. Such spillage of saline may result in that the sealing foil may be incompletely sealed to the top surface of the respective primary packaging shell. However, if only one primary package of the plurality of primary packages of the blister strip is incompletely sealed, the whole blister strip must be discarded thus negatively affecting the production yield.

It is therefore an object of the invention to provide a sealing device and a method overcoming the afore-mentioned disadvantages.

### SUMMARY OF THE INVENTION

In accordance with the present invention, these and other objects are met by a sealing device and a method for sealing a sealing foil onto a top surface of a primary packaging shell for an ophthalmic article such as an ophthalmic lens, in particular a contact lens such as a soft contact lens, as specified by the features of the independent claims. Advantageous aspects of the sealing device and the method according to the invention are the subject of the dependent claims.

As used in the specification including the appended claims, the singular forms “a”, “an”, and “the” include the plural, unless the context explicitly dictates otherwise. When using the term “about” with reference to a particular numerical value or a range of values, this is to be understood in the sense that the particular numerical value referred to in connection with the term “about” is included and explicitly disclosed, unless the context clearly dictates otherwise. For example, if a range of “about” numerical value A to “about” numerical value B is disclosed, this is to be understood to include and explicitly disclose a range of numerical value A to numerical value B. Also, whenever features are combined with the term “or”, the term “or” is to be understood to also include “and” unless it is evident from the specification that the term “or” must be understood as being exclusive.

According to the invention, a sealing device for sealing a sealing foil onto a top surface of a primary packaging shell for an ophthalmic article such as an ophthalmic lens, in particular a contact lens such as a soft contact lens, is suggested. The sealing device comprises:
a shell support for supporting the primary packaging shell,
a heatable sealing head arranged above the shell support, the sealing head comprising a contact surface facing downwardly towards the shell support, and
at least one linear actuator for performing a vertical relative movement of the shell support and the sealing head towards and away from each other between an open position, in which the contact surface of the sealing head is arranged vertically spaced above the shell support by a predetermined distance such that when a primary packaging shell is supported by the shell support there is a vertical gap between the contact surface of the sealing head and a top surface of the primary packaging shell arranged on the shell support, and a closed position, in which the contact surface of the sealing head is arranged to press the sealing foil against a sealing portion of the top surface of the primary packaging shell that is defined by the contact surface of the sealing head.

The sealing device further comprises a foil holder for holding the sealing foil, the foil holder being arranged to hold the sealing foil at a foil provision position which is spaced by a first predetermined distance from the contact surface of the sealing head and by a second predetermined distance from the top surface of the primary packaging shell in the vertical gap between the contact surface of the sealing head and the top surface of the primary packaging shell when the primary packaging shell is supported by the shell support, such that upon relative movement of the shell support and the sealing head towards each other the sealing foil is sealed to the top surface of the primary packaging shell along the sealing portion.

According to one aspect of the sealing device according to the invention, the shell support comprises a support top surface for supporting the primary packaging shell, and the sealing head comprises a sealing rim protruding downwardly and having the contact surface, the contact surface facing the support top surface of the shell support.

According to another aspect of the sealing device according to the invention, the sealing device further comprises a force sensor coupled to the shell support for measuring a sealing force exerted by the sealing head onto the shell support.

According to yet another aspect of the sealing device according to the invention, the foil holder is movable horizontally between a foil delivery position, in which the sealing foil is held at the foil provision position, and a foil receiving position for placing the sealing foil on the foil holder, the foil receiving position being horizontally displaced relative to the foil delivery position.

According to a further aspect of the sealing device according to the invention, the sealing device further comprises a foil gripper for gripping the sealing foil from a foil magazine and placing it on the foil holder.

According to another aspect of the sealing device according to the invention, the at least one linear actuator comprises a first linear actuator operatively coupled to the shell support, for performing a vertical movement of the shell support towards and away from the sealing head, and a second linear actuator operatively coupled to the sealing head, for performing a vertical movement of the sealing head towards and away from the shell support.

According to yet another aspect of the sealing device according to the invention, the shell support further comprises a hollow cylinder having a circumferentially running cylinder wall, with a top surface of the circumferentially running cylinder wall forming the support top surface for supporting the primary packaging shell.

According to a further aspect of the sealing device according to the invention, the hollow cylinder comprises a vacuum supply port for the supply of vacuum through an interior space of the hollow cylinder to suck the primary packaging shell against the top surface of the circumferentially running cylinder wall.

According to another aspect of the sealing device according to the invention, the shell support further comprises a ring made of an elastic material, in particular silicone, which is arranged to form the top surface of the circumferentially running cylinder wall.

According to yet another aspect of the sealing device according to the invention, the sealing device is configured for sealing a plurality of sealing foils which are connected to one another to form a sealing foil strip to the top surfaces of a corresponding plurality of primary packaging shells. The sealing device comprises:
a plurality of said shell supports, each shell support of the plurality of said shell supports for supporting one primary packaging shell of the plurality of primary packaging shells;
a plurality of said sealing heads corresponding to the plurality of said shell supports, each sealing head of the plurality of said sealing heads having a said contact surface facing towards one shell support of the plurality of the said shell supports;
   wherein the foil holder is configured to hold each sealing foil of the plurality of sealing foils of the sealing foil strip in the respective foil provision position.

According to a further aspect of the sealing device according to the invention, the sealing device further comprises a plurality of said force sensors corresponding to the plurality of said shell supports, each force sensor of the plurality of said force sensors coupled to a respective one shell support of the plurality of said shell supports for measuring the individual sealing force exerted by the respective sealing head of the plurality of sealing heads onto the respective one shell support of the plurality of shell supports to which the respective force sensor of the plurality of force sensors is coupled.

According to another aspect of the sealing device according to the invention, the sealing device further comprises at least one movable carrier for transporting the primary packaging shell or the plurality of primary packaging shells and arranging the primary packaging shell or the plurality of primary packaging shells underneath the sealing head or the plurality of sealing heads.

According to yet another aspect of the sealing device according to the invention, the at least one movable carrier comprises a carrier body for carrying the primary packaging shell and an opening extending vertically through the carrier body, and wherein each shell support is vertically movable upwards through the opening extending through the carrier body to lift the primary packaging shell from the movable carrier so as to be supported by the respective shell support.

According to the invention, a method for sealing a sealing foil onto a top surface of a primary packaging shell for an ophthalmic article such as an ophthalmic lens, in particular a contact lens such as a soft contact lens, is suggested, too. The method comprises the steps of:
providing the primary packaging shell on a shell support;
arranging the shell support with the primary packaging shell arranged thereon at a position vertically spaced from a heatable sealing head and underneath the sealing head, the sealing head comprising a contact surface protruding downwardly from the sealing head towards a top surface of the primary packaging shell such that there is a vertical gap between the contact surface of the sealing head and the top surface of the primary packaging shell;
providing a sealing foil at a foil provision position vertically spaced from the contact surface of the sealing head by a first predetermined distance;
heating the sealing head to a predetermined sealing temperature;
vertically moving the sealing head and the shell support with the primary packaging shell arranged thereon relative to each other until the contact surface of the sealing head presses the sealing foil against the top surface of the primary packaging shell to seal the sealing foil to the top surface of the primary packaging shell along a sealing portion defined by the contact surface of the sealing head.

The foil provision position of the sealing foil is vertically spaced from the top surface of the primary packaging shell by a second predetermined distance,

and in that vertically moving the sealing head and the shell support with the primary packaging shell arranged thereon is performed such that the sealing foil comes into contact with the top surface of the primary packaging shell and with the contact surface of the sealing head at the same time.

According to one aspect of the method according to the invention, the method is performed using a sealing device as describe above.

The sealing device according to the invention is advantageous in that it allows the sealing foil to be arranged in the vertical gap between the contact surface of the sealing head and the top surface of the primary packaging shell, such that the sealing foil does neither contact the top surface of the primary packaging shell nor the contact surface of the sealing head when the shell support and the sealing head are in the open position. Thus, spillage of storage solution onto the top surface of the primary packaging shell caused by capillary forces of the sealing foil resting on the top surface of the primary packaging shell to which the sealing foil is to be sealed are avoided, as the sealing foil comes into contact with the top surface of the primary packaging shell only at the time the contact surface of the sealing head presses the sealing foil against the top surface of the primary packaging shell to perform the sealing operation. Incomplete sealing of the sealing foil to the top surface of the primary packaging shell due to spillage of storage solution is thus avoided.

Accordingly, the first predetermined vertical distance of the foil provision position of the sealing foil from the top surface of the primary packaging shell when arranged at the foil provision position in the vertical gap is chosen large enough so that no capillary forces may occur between the top surface of the primary packaging shell and the sealing foil. For instance, the first predetermined distance may be in a range of 10 millimeters and 40 millimeters.

Similarly, the second predetermined distance of the foil provision position of the sealing foil from the contact surface of the sealing head is chosen such that the sealing foil is not get deformed by the heat of the heated sealing head and that the adhesive layer of the sealing foil is not melted prior to the foil being sealed onto the top surface of the primary packaging shell. For instance, the second predetermined distance may be in a range of 20 millimeters and 80 millimeters.

Thus, in the present invention the sealing foil comes into contact with the top surface of the primary packaging shell and with the contact surface of the sealing head at the same time. In this regard, the term “at the same time” is to be understood as outlined above: Capillary forces between the sealing foil and the top surface of the primary packaging shell that may draw any storage liquid from the cavity of the primary packaging shell to a location on the top surface of the primary packaging shell between the sealing foil and the top surface of the primary packaging shell prior to sealing are to be avoided on one hand, and on the other hand deformation of the sealing foil and/or melting of the adhesive layer of the sealing foil prior to sealing is to be avoided, too. This means that the contact between the foil and the top surface of the primary packaging shell and the contact between the foil and the contact surface of the sealing head ideally occurs exactly at the same time. However, differences of up to 200 milliseconds may typically be tolerated without affecting the desired result described above.

To move the shell support and the sealing head (with its contact surface) vertically towards each other to perform the sealing operation, the at least one linear actuator may comprise only one linear actuator for performing a vertical movement of the shell support to lift the primary packaging shell up from the (shell) carrier and move it towards the sealing head, while the sealing head is arranged stationary. Alternatively, the at least one linear actuator may comprise a second linear actuator, so that the shell support may be moved towards the sealing head as described above, while at the same time the sealing head is moved towards the shell support, too.

Generally, the sealing temperature depends on the materials used for the foil and the primary packaging shell. However, typically the sealing temperature may be in a range of 140° C. and 230° C., more particularly in a range of 170° C. and 210° C., and the sealing duration (duration of pressing the sealing foil onto the top surface of the primary packaging shell is between 0.5 seconds and 5 second, more particularly between 1 second and 2 seconds.

In the closed position, i.e. when the contact surface of the heatable sealing head is arranged to press the sealing foil against the top surface of the primary packaging shell, a sealing force in a range between 300 Newtons and 600 Newtons may be exerted for the afore-mentioned duration in a range between 0.5 seconds and 5 seconds, in particular in a range between 1 second and 2 seconds. Thereby, the sealing foil is thermally bonded to the top surface of the primary packaging shell along a sealing portion that is defined by the shape of the contact surface of the sealing head, to sealingly cover the concave cavity of the primary packaging shell containing the ophthalmic article and, if present, the storage solution.

The foil holder may be horizontally movable between a foil receiving position and a foil delivery position, such that the sealing foil may be placed on the foil holder at the foil receiving position which may subsequently be moved to the foil delivery position. Alternatively, the foil holder may be fixedly arranged at the foil delivery position, and a new foil is placed on the foil holder after each sealing operation is completed and the sealing head and the shell support are moved away from each other.

The sealing rim and its contact surface may be shaped such that the shape of the contact surface is similar to the shape of the boundary delimiting the cavity of the primary packaging shell, but is a little larger than this boundary. The shape of the sealing surface further corresponds in shape to the shape of the support top surface of the shell support that supports the primary packaging shell at the time the foil is sealed to the top surface of the primary packaging shell. Thus, upon sealing the sealing foil to the top surface of the primary packaging shell, the sealing portion along which the seal seam is formed corresponds in shape to the shape of the boundary delimiting the cavity. This results in the formation of a proper seal seam which is advantageous as regards the desired peel forces to be applied for peeling the foil off of the top surface of the primary packaging shell at the time of opening the sealed primary package.

The sealing force exerted onto the support surface corresponds to the sealing force exerted onto the foil and the sealing portion of the top surface of the primary packaging shell. Measurement of the sealing force with the aid of a force sensor allows to identify sealing operations in which the exerted sealing force is outside a predetermined acceptable range of forces. In case of too high a sealing force, the sealing foil may get sealed to the top surface of the primary packaging shell too strongly so that it may not be peeled off or too high a peel force is required, or the sealing foil may get damaged. In case of too low a sealing force, the sealing foil may not get properly sealed onto the top surface of the primary packaging shell and may thus negatively affect the sealing integrity. Thus, sealing force measurement helps identify primary packages which may not be sealed within the given specifications. A suitable force sensor is described, for instance, in WO 2022/054015 A1.

A foil holder that is movable horizontally between the foil delivery position and the foil receiving position is advantageous in that the sealing foil can be easily placed on the foil holder at the foil receiving position and then transferred by the foil holder to the foil delivery position in which the foil is held at the foil provision position. This allows to provide a sealing foil magazine at a location remote from the foil provision position, from which the foil can be picked and placed on the foil holder when the foil holder is in the foil receiving position. By way of example, a foil holder may be embodied as kind of a movable tray having one or more openings for receiving one or more sealing foils therein and hold them on the foil holder. The foil holder may subsequently be horizontally moved along a rail to the foil delivery position in which the one or more foils are held at the foil provision position. For moving the foil holder along the rail, the foil holder may be coupled to a linear actuator that moves the foil holder horizontally between the foil provision position and the foil delivery position.

A foil gripper may be provided for gripping the sealing foil from a foil magazine and placing it on the foil holder. For instance, the foil gripper may comprise a vacuum gripper which is coupled to an actuator to pick a sealing foil from the foil magazine and place the sealing foil from the foil magazine to the foil holder which is positioned in the foil receiving position.

In case the shell support comprises a hollow cylinder having a circumferentially running cylinder wall, this may be advantageous in that it is weight-saving while at the same time it allows the supply of vacuum through a vacuum port to the interior of the cylinder. The vacuum allows to securely hold the primary packaging shell sucked against the top surface of the cylinder. For the supply of vacuum the cylinder may be provided with a suction port through which the vacuum may be supplied to the interior of the cylinder. A ring made of an elastic material such as silicone may be arranged on the support top surface of the cylinder wall to additionally support the primary packaging shell when the heated sealing head presses the sealing foil against the top surface of the primary packaging shell during the sealing operation. In case the sealing force applied by the sealing head is not uniform, the silicone ring may help equalizing the sealing force.

A plurality of shell supports and sealing heads allows for the concurrent sealing of a plurality of primary packaging shells with a corresponding plurality of sealing foils in one sealing cycle, thus increasing the efficiency of the sealing process. The individual sealing foils of the said plurality of sealing foils may form a sealing foil strip, the individual sealing foils of which are connected to one another and are separable from one another. Thus, concurrently sealing the individual foils of a said strip to the plurality of primary packaging shells leads to the formation of a blister strip of sealed primary packages. An individual sealed primary package (a blister) may be then separated from the so formed blister strip on demand.

A plurality of force sensors may be provided, with each force sensor being coupled to a respective one of the plurality of shell supports. This allows for the measurement of the respective individual sealing force applied to the respective primary packaging shell (and thus to the respective sealing foil). The force may be stored in a database, so that for each individual sealed primary package the sealing force that has been applied during the sealing operation is available which may help identifying primary packages for which either too high a sealing force or too low a sealing force has been applied.

The individual primary packaging shells may be transported on a movable carrier for transporting the primary packaging shell to a position underneath the sealing head to allow the sealing operation to be performed, and for subsequently transporting the sealed primary package away for further processing. Advantageously, a plurality of such movable carriers are provided.

The shell carrier may comprise an opening extending vertically through the carrier body, through which the shell support is vertically movable upwards to lift the primary packaging shell from the carrier and move the primary packaging shell towards the sealing head, with the primary packaging shell being supported by the shell support. Once the sealing operation is completed, the shell support may again be moved vertically downwards to allow the sealed primary package to rest on the carrier again, so that the carrier with the sealing primary package resting thereon may then be moved away for further processing.

The method according to the invention offers the same advantages as the sealing device according to the invention, so that they are not reiterated. Advantageously, the method according to the invention is carried out using the sealing device according to the invention, as described above.

### BRIEF DESCRIPTION OF THE DRAWINGS

Further advantageous aspects of the invention become apparent from the following description of embodiments of the invention with the aid of the (schematic) drawings, in which:

FIG. 1 shows a perspective view of some components of an embodiment of the sealing device according to the invention;

FIG. 2 shows a perspective view of the components of FIG. 1 arranged in an initial open position (prior to sealing);

FIG. 3 shows a side view of the components arranged in the initial position of FIG. 2;

FIG. 4 shows a perspective view of the components shown in FIG. 1-3 arranged in an intermediate position;

FIG. 5 shows a perspective view of the components shown in FIG. 1-4 in a closed position (during sealing);

FIG. 6 shows a perspective view of the components in a final open position (after sealing);

FIG. 7 shows a perspective view of an embodiment of the sealing device according to the invention;

FIG. 8 shows a top view of the embodiment of the sealing device of FIG. 7;

FIG. 9 shows a cross-sectional view along plane IX-IX indicated in FIG. 8;

FIG. 10 shows an enlarged view of the detail X of FIG. 9;

FIG. 11 shows a perspective view of a plurality of shell supports;

FIG. 12 shows a top view of the plurality of shell supports of FIG. 11;

FIG. 13 shows a cross-sectional view along plane XIII-XIII indicated in FIG. 12;

FIG. 14 shows a perspective view of a carrier without a primary packaging shell arranged thereon;

FIG. 15 shows a top view of the carrier of FIG. 14 with a primary packaging shell arranged thereon; and

FIG. 16 shows a perspective view of the carrier of FIG. 15 with the primary packaging shell arranged thereon.

### DETAILED DESCRIPTION OF EMBODIMENTS

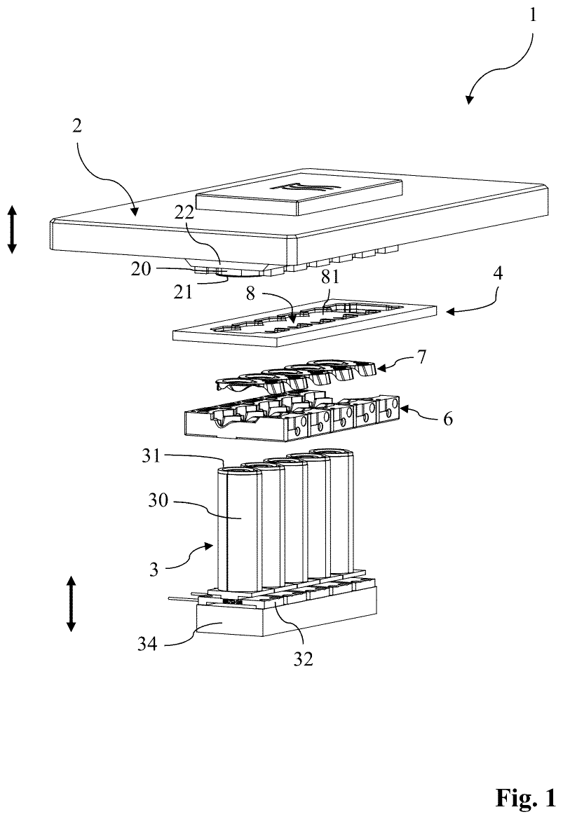

An embodiment of essential components of a sealing device 1 according to the invention is shown in an exploded perspective view in FIG. 1. Sealing device 1 comprises a plurality of sealing heads 22 which are part of a sealing block 2. Each of the sealing heads 22 comprises a sealing rim 20 protruding downwardly. Each sealing rim 20 has a contact surface 21 facing downwards. The sealing heads 22 are thermally coupled to a heating device (not shown in drawings) to heat the sealing heads 22 to a sealing temperature which, by way of example, may be in a range of 140° C. and 230° C., especially between 170° C. and 210° C. Sealing block 2 with the sealing heads 22 arranged thereon is operatively coupled with a linear actuator (not shown in the drawings) for performing a vertical movement of sealing block 2 and the sealing heads 22 upwards and downwards (as indicated by the associated double-headed arrow at the left hand side).

Sealing device 1 further comprises a plurality of shell supports 3 which are arranged on a shell support block 34. Each shell support 3 is for supporting a primary packaging shell 7 of a plurality of primary packaging shells 7. Each primary packaging shell 7 contains one ophthalmic article contained in a cavity formed therein. In the case of a soft contact lens as the ophthalmic article, a storage solution (e.g. saline) is also contained in the cavity of the primary packaging shell 7 where the soft contact lens is contained. In other cases, e.g. when the ophthalmic article is a film that must be stored in a dry state and that is to be wetted only shortly before use, no storage solution is contained in the cavity of the primary packaging shell 7. Each of the shell supports 3 comprises a hollow cylinder 30 which has a top surface forming a support top surface 31 for supporting the primary packaging shell 7 arranged thereon. The support top surfaces 31 are facing upwards, and each of the support top surfaces 31 faces one respective contact surface 21 of a sealing rim 20 that faces downwards. Shell support block 34 with the shell supports 3 arranged thereon is operatively coupled with a linear actuator (not shown in the drawings) for performing a vertical movement of shell support block 34 and the shell supports 3 upwards and downwards (as indicated by the associated double-headed arrow on the left-hand side).

Sealing device 1 further comprises a plurality of force sensors 32, one force sensor 32 arranged between each shell support 3 and the shell support block 34, for measuring a respective sealing force exerted by the respective sealing head 22 onto the shell support 3. Force sensors 32 may be embodied as described for instance in WO 2022/054015 A1.

Sealing device 1 further comprises a foil holder 4 for holding a plurality of sealing foils 81 at a foil provision position in a vertical gap between the contact surface 21 and the support top surface 31 as well as underneath the plurality of sealing heads 22. The plurality of sealing foils 81 are connected to one another to form a sealing foil strip 8.

Sealing device 1 further comprises a plurality of movable carriers 6, each carrier 6 being a single shell carrier for transporting one primary packaging shell 7 of the plurality of primary packaging shells 7. The plurality of (individual) carriers 6 are for transporting the plurality of primary packaging shells 7 in a horizontal direction to a position underneath the plurality of sealing heads 22 and away therefrom.

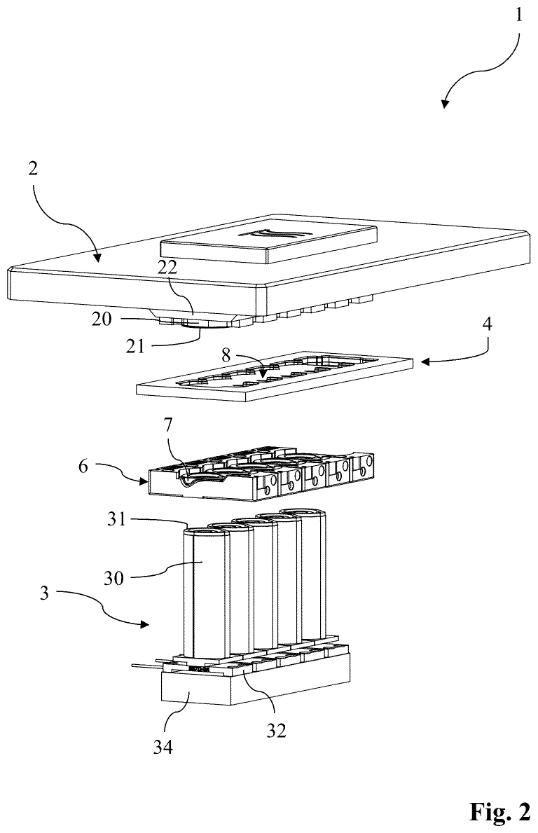

In the following, various steps for sealing the plurality of sealing foils 81 of sealing foil strip 8 onto the top surfaces of a plurality of primary packaging shells 7 are described with the help of FIGS. 2 to 6.

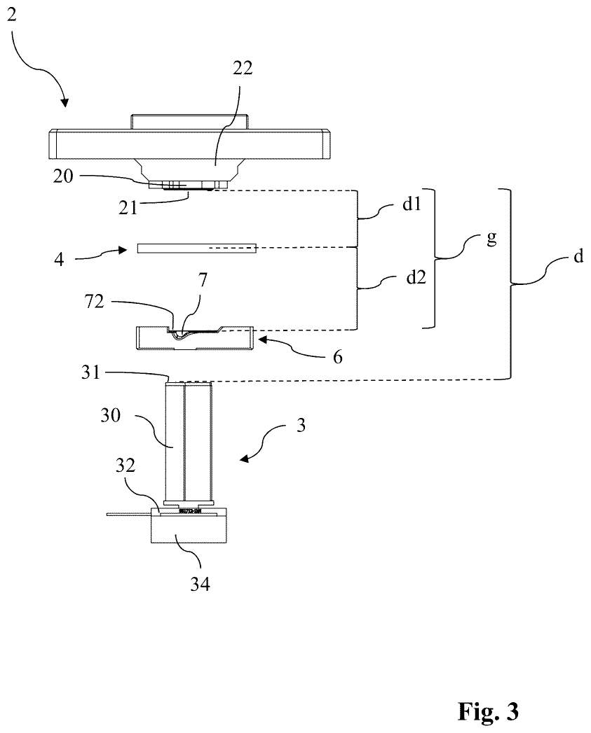

FIG. 2 shows a perspective view of the components of FIG. 1 in an initial open position (prior to sealing), and FIG. 3 shows a side view of the sealing device 1 in the same initial open position.

In this initial open position, the plurality of sealing heads 22 and the plurality of shell supports 3 are arranged spaced apart from each other such that each contact surface 21 of each sealing head 22 is spaced by a predetermined distance d from the support top surface 31 of the respective associated shell support 3.

The primary packaging shells 7 are arranged on the carriers 6 between the contact surfaces 21 of the sealing heads 22 and the support top surfaces 31 of the shell supports 3 such that there is a vertical gap g between the respective contact surface 21 and a top surface 72 of the respective associated primary packaging shell 7 arranged on the respective associated carrier 6.

The sealing foil strip 8 is held by the foil holder 4 in the vertical gap g at the foil provision position which is spaced from the contact surfaces 21 of the sealing heads 22 by a first predetermined distance d1. For example, this predetermined distance d1 may be in a range of 20 millimeters and 80 millimeters. The foil provision position is spaced from the top surfaces 72 of the primary packaging shells 7 by a second predetermined distance d2. For example, this predetermined distance is in a range of 10 millimeters and 40 millimeters.

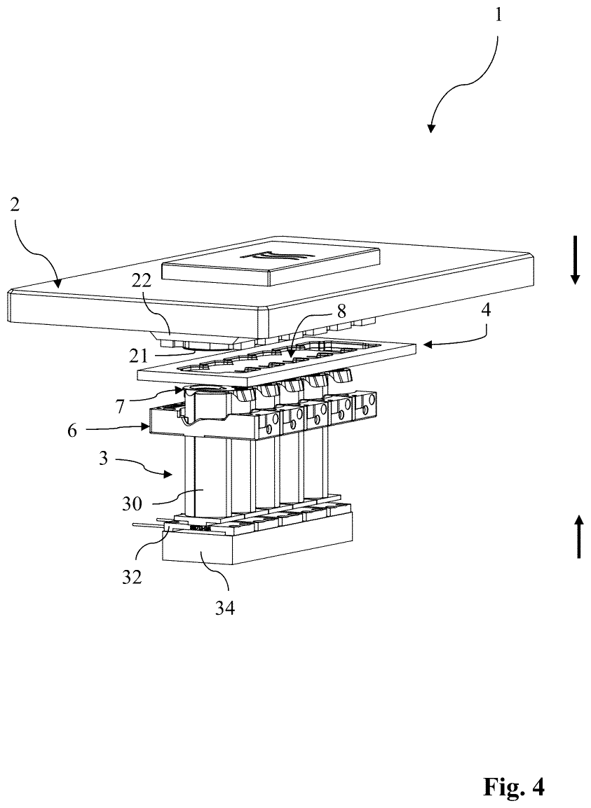

FIG. 4 shows the components of the sealing device 1 of FIGS. 1 to 3 in an intermediate position, in which the sealing heads 22 and the shell supports 3 have been moved towards each other. In particular, the shell support block 34 with the plurality of shell supports 3 arranged thereon has been moved by the (first) linear actuator upwards (indicated by the arrow pointing upwards) compared to the initial open position shown in FIG. 2 and FIG. 3.

During the upward movement of the shell supports 3, the primary packaging shells 7 have been lifted from the carriers 6 by the plurality of shell supports 3. Each of the primary packaging shells 7 is then supported from beneath by one of the support top surfaces 31 of the respective associated shell support 3.

The sealing head block 2 with the plurality of sealing heads 22 arranged thereon has been moved by the (second) linear actuator downwards (indicated by the arrow pointing downwards) in a direction towards the shell supports 3 and the primary packaging shells 7 arranged thereon.

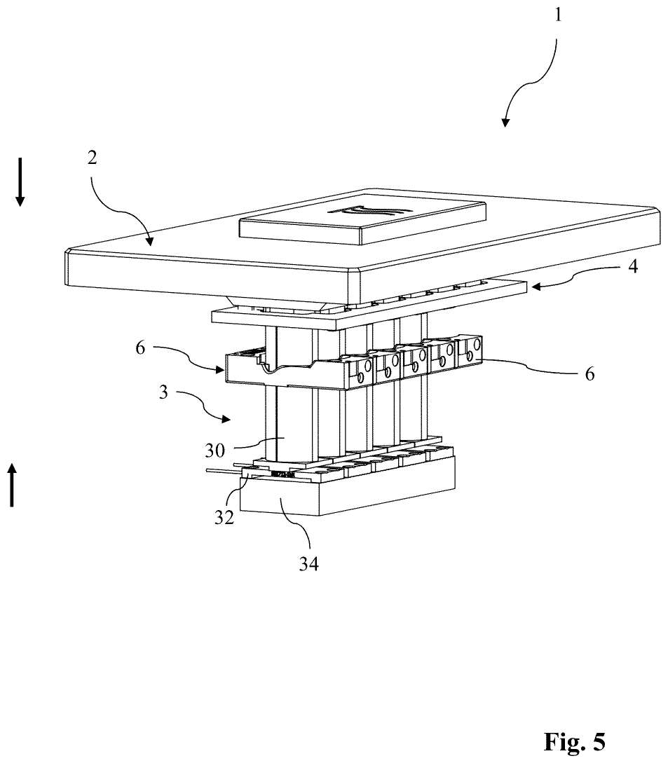

FIG. 5 shows the sealing device 1 in a closed position (sealing position) in which the sealing foil strip 8 is sealed onto the top surfaces 72 of the primary packaging shells 7, one individual foil 81 (of the foil strip 8) onto the top surface 72 of the primary packaging shell 7 arranged on the associated carrier 6.

To perform the sealing operation, sealing head block 2 with the plurality of sealing heads 22 arranged thereon and shell support block 34 with the plurality of shell supports 3 arranged thereon have been moved towards each other into the closed position (sealing position), as is indicated by the two arrows in FIGS. 5.

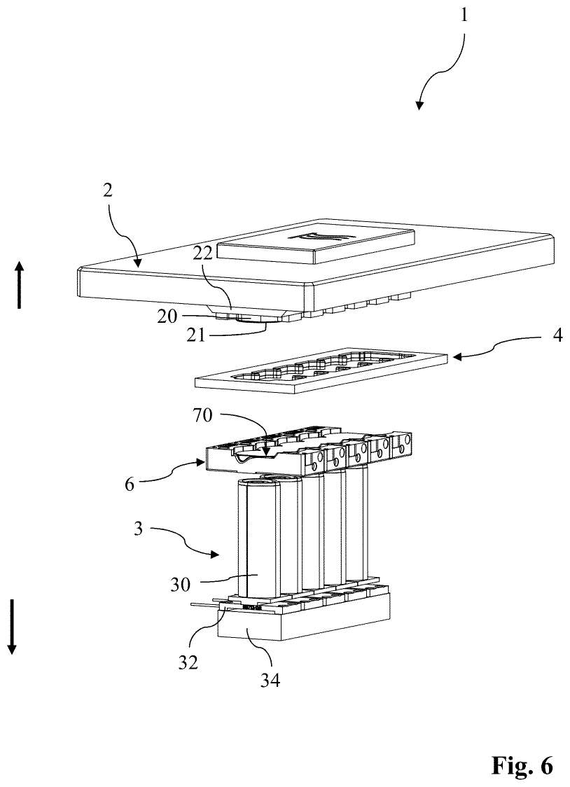

In this closed position (sealing position), each of the contact surfaces 21 of the sealing heads 22 presses the respective sealing foil 81 of sealing foil strip 8 against the respective top surface 72 of the primary packaging shells 7 supported by the shell supports 3. The sealing heads 22 are heated to a suitable sealing temperature that may be, for example, in the range of 170° C. to 210° C. These temperatures are, however, only exemplary as they may depend on the material the sealing foil is made of and the thickness of the sealing foil. Each of the respective individual sealing foils 81 of the sealing foil strip 8 is thus thermally bonded to the respective top surface 72 of the primary packaging shell 7 arranged on the support top surface 31 of the respective shell support 3. Sealing of the sealing foils 81 of the sealing foil strip to the primary packaging shells 7 is performed along a respective sealing portion of the top surface 72 of the respective primary packaging shell 7, with the shape of this sealing portion being defined by the shape of the contact surface 21 of the respective sealing head 22. A suitable sealing force may be in a range of 300 Newtons to 600 Newtons, and may be exerted for a duration in a range of 0.5 seconds and 5 seconds, in particular in a range of 1 second to 2 seconds. Since the individual sealing foils 81 of the foil strip 8 are connected to one another, a blister strip of sealed primary packages 70 (FIG. 6) is thus formed.

Force sensors 32 are provided to measure the individual sealing force exerted by the respective sealing head 22 onto the respective shell support 3 supporting the respective primary packaging shell 7 arranged thereon. As already mentioned, suitable force sensors 32 may be embodied as described in WO 2022/054015 A1. The measured individual sealing forces may be stored in a database for tracking purposes.

Thereafter, the shell supports 3 with the sealed primary packages 70 arranged thereon and the sealings heads 22 arranged on the sealing block 2 need to be moved away from one another to allow the blister strip of sealed primary packages 70 to be transported away from the position underneath the sealing heads 22. To achieve this, the shell supports 3 are lowered again while the sealing heads 22 arranged on the sealing block 2 are raised again (see the two arrows in FIG. 6) until they reach a final open position shown in FIG. 6. In this final open position, the individual sealed primary packages 70 of the blister strip of sealed primary packages 70 rest on the individual carriers 6 again, so that the blister strip of sealed primary packages 70 is carried by the plurality of individual carriers 6, one sealed primary package by each individual carrier 6. The carriers 6 with the blister strip of sealed primary packages 70 may then be transported away from the position underneath the sealing heads, and the next primary packaging shells 7 each containing a lens and a storage solution may subsequently be transported to the position underneath the sealing heads 22 and above the shell supports 3, whereupon the described sealing operation may be performed again in the manner describe above.

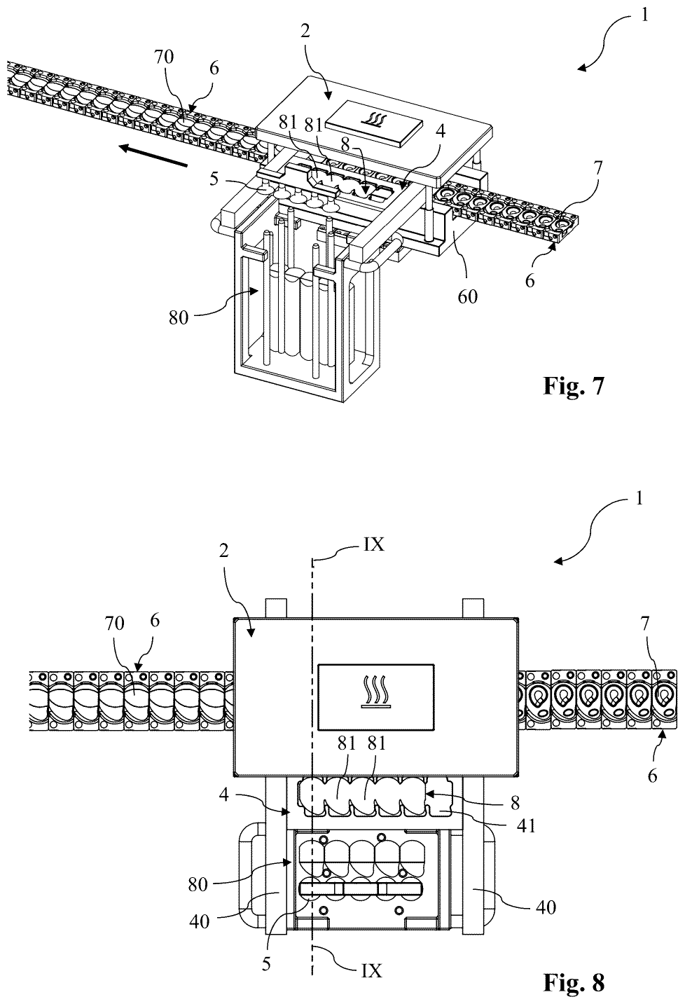

FIG. 7 shows a perspective view of an embodiment of the sealing device according to the invention, and FIG. 8 shows a top view of the embodiment of the sealing device of FIG. 7.

The primary packaging shells 7 (with a lens and storage solution arranged in each cavity) are arranged on the movable carriers 6, and are transported in a horizontal direction (indicated by the arrow) to a position underneath the sealing heads 22 arranged on the sealing block 2 and above the shell supports 3 arranged on the shell support block 34 (see FIG. 2). Movable carriers 6 are guided in the direction of transportation by a carrier guide 60 (only a portion thereof being shown in FIG. 7). After the sealing foil strip 8 has been sealed to the top surfaces 72 of the plurality of primary packaging shells 7 to form the blister strip of sealed primary packages 70, as described above, the movable carriers 6 with the sealed primary packages 70 arranged thereon are transported away from the position underneath the sealing heads 22, and the next plurality of primary packaging shells 7 arranged on the next plurality of movable carriers are moved into the position underneath the sealing heads 22.

For providing a plurality of stacked sealing foil strips 8, sealing device 1 may comprise a sealing foil magazine 80. In addition, sealing device 1 comprises a plurality of foil grippers 5 configured and arranged for picking the uppermost sealing foil strip 8 from the sealing foil magazine 80 and for placing the sealing foil strip 8 on the foil holder 4 while the foil holder 4 is arranged in a foil receiving position. In the embodiment of the sealing device 1 shown in FIG. 7 and FIG. 8, the foil grippers 5 are suction cups (vacuum grippers) for sucking the uppermost sealing foil strip 8 from the stack of sealing foil strips 8 contained in the sealing foil magazine 80 and placing it into a correspondingly shaped foil receiving opening 41 of foil holder 4 by the application of a small overpressure. Foil holder 4 with the sealing foil strip 8 placed thereon is then transported along a pair of rails 40 into a delivery position in which the sealing foil strip 8 comprising the individual foils 81 is provided at the foil provision position underneath the sealing heads 22. Sealing the individual foils 81 of the sealing foil strip 8 to the top surfaces 72 of the primary packaging shells 7 is then performed in the manner described above with the aid of FIG. 1-FIG. 6. As can be seen in FIG. 7 and FIG. 8, the foil receiving opening 41 of foil holder 4 comprises six compartments of which only five contain a foil 81. This allows to also manufacture blister strips of either six sealed primary packages 70 or, alternatively, to concurrently manufacture two blister strips each comprising only three sealed primary packages 70. Strips of other numbers smaller than six can be manufactured as well.

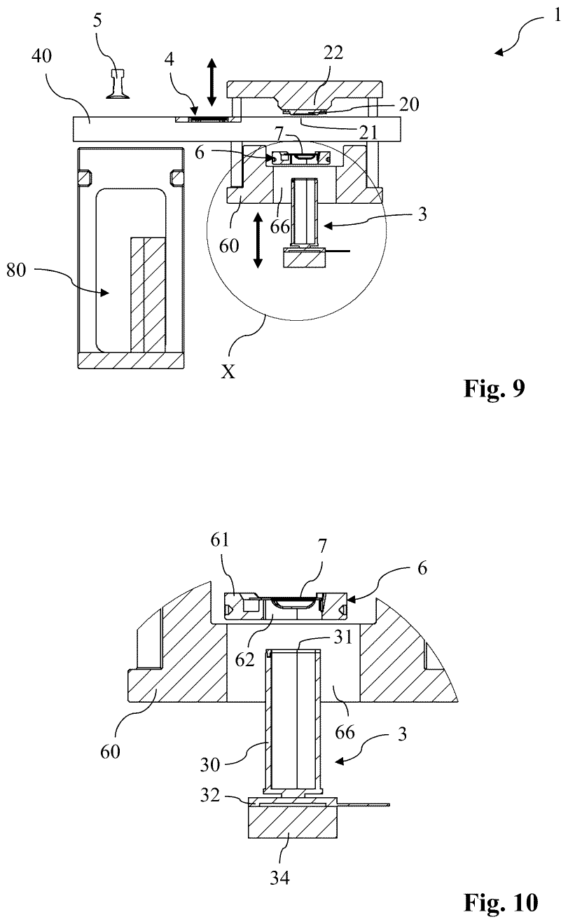

From the cross-sectional view in FIG. 9 and the detail X in FIG. 10, it can be taken that the carrier guide 60 comprises a vertical opening 66 through which the plurality of shell supports 3 can be moved vertically up and down, as is indicated by the double-headed arrow in FIG. 9. The width of this opening 66 of carrier guide 60 is shown overly large, as it is clear that the width of opening 66 can only be such that the carriers 6 with their carrier bodies 61 rest on and are supported and guided by the carrier guide 60. To lift the primary packaging shells 7 carried by the carriers 6, each carrier 6 comprises an opening 62 (FIG. 10) through which the shell support 3 is movable upwards to lift the primary packaging shell 7 up from the respective carrier 6 and have it supported by the shell support 3 for getting sealed in the manner described above.

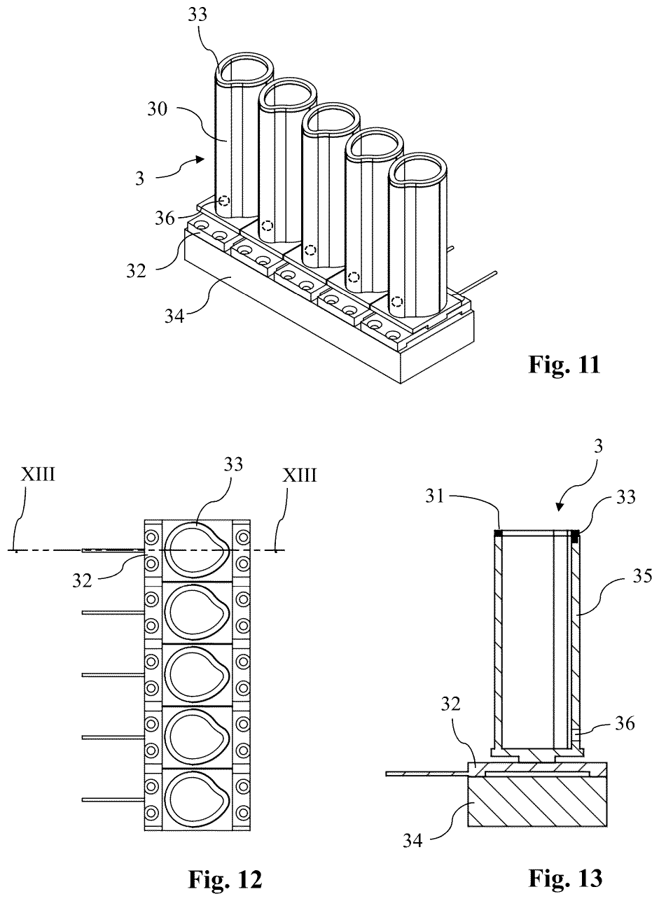

A plurality of shell supports 3 (in the embodiment shown five such shell supports 3) arranged on the shell support block 34 are shown in more detail in FIG. 11, FIG. 12 and FIG. 13 in a perspective view (FIG. 11), a top view (FIG. 12) and a cross-sectional view (FIG. 13), respectively.

Each shell support 3 comprises a hollow cylinder 30 having a circumferentially running cylinder wall 35. A top surface of the circumferentially running cylinder wall 35 forms the support top surface 31 of the shell support 3. Each support top surfaces 31 comprises a groove (not shown in detail) arranged therein, and a silicone ring 33 is arranged in the said groove. Each shell support 3 further comprises a vacuum supply port 36 to allow suction to be supplied to an interior space of the hollow cylinder 30 enclosed by the cylinder wall 35.

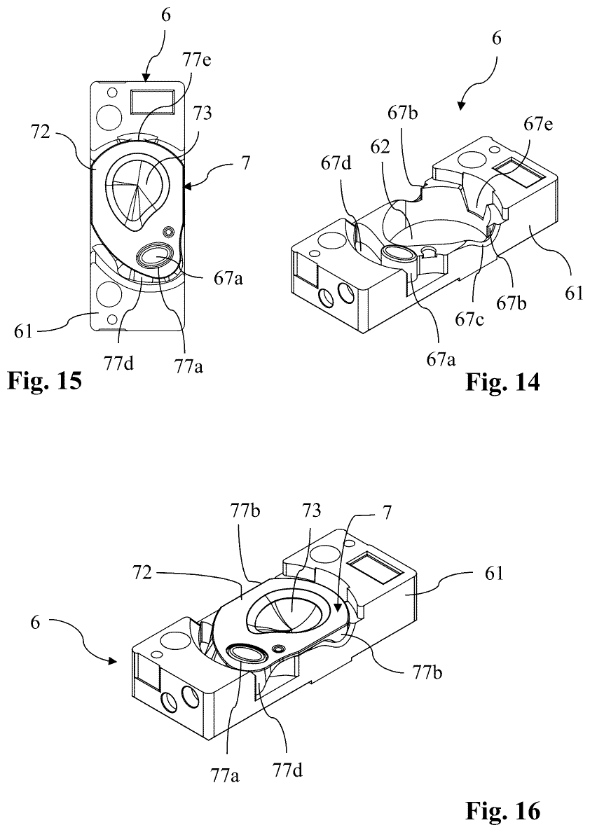

FIG. 14 shows a carrier 6 without a primary packaging shell 7 being arranged thereon, while FIG. 15 (top view) and FIG. 16 (perspective view) show the carrier 6 with a primary packaging shell 7 arranged thereon. As can be seen best in FIG. 14, carrier 6 comprises carrier body 61 and opening 62 to allow shell support 3 to be moved through the opening 62 to lift primary packaging shell 7 off of carrier 6, as this has been described above. To make sure primary packaging shell 7 is accurately positioned on carrier 6 (see FIG. 15 and FIG. 16), carrier 6 comprises a number of positioning features. These positioning features comprise a post 67a for engaging with a corresponding opening 77a of primary packaging shell 7 and two lateral abutment flange portions 67b for engaging with corresponding lateral flanges 77b of primary packaging shell 7, as well as recesses 67c for accommodating the flanges 77b. Yet further, carrier 6 comprises a larger recess 67d for accommodating a corresponding larger flange 77d of primary packaging shell 7, as well as a further recess 67e for receiving a corresponding flange 77e of the primary packaging shell 7. These features taken together allow for an accurate positioning of the primary packaging shell on carrier 6 in a well-defined position and orientation, as is shown in FIG. 15 and FIG. 16. Also, the top surface 72 of primary packaging shell to which the sealing foil 81 is sealed as well as the concave cavity 73 in which the ophthalmic article, e.g. the soft contact lens (together with storage solution), is contained (not shown in the drawings) can be seen in FIG. 15 and FIG. 16.

Embodiments of the sealing device of the present invention have been described with the aid of the drawings. However, the invention is not limited to these embodiments. Rather, various changes and modifications can be made without departing from the teaching underlying the instant invention. The scope of protection is therefore defined by the appended claims.

1. Sealing device (1) for sealing a sealing foil (81) onto a top surface (72) of a primary packaging shell (7) for an ophthalmic article such as an ophthalmic lens, in particular a contact lens such as a soft contact lens, the sealing device (1) comprising:
a shell support (3) for supporting the primary packaging shell (7),
a heatable sealing head (22) arranged above the shell support (3), the sealing head (22) comprising a contact surface (21) facing downwardly towards the shell support (3), and
at least one linear actuator for performing a vertical relative movement of the shell support (3) and the sealing head (22) towards and away from each other between an open position, in which the contact surface (21) of the sealing head (22) is arranged vertically spaced above the shell support (3) by a predetermined distance (d) such that when a primary packaging shell (7) is supported by the shell support (3) there is a vertical gap (g) between the contact surface (21) of the sealing head (22) and a top surface (72) of the primary packaging shell (7) arranged on the shell support (3), and a closed position, in which the contact surface (21) of the sealing head (22) is arranged to press the sealing foil (81) against a sealing portion of the top surface (72) of the primary packaging shell (7) that is defined by the contact surface (21) of the sealing head (22),
characterized in that the sealing device further comprises
a foil holder (4) for holding the sealing foil (81), the foil holder (4) being arranged to hold the sealing foil (81) at a foil provision position which is spaced by a first predetermined distance (d1) from the contact surface (21) of the sealing head (22) and by a second predetermined distance (d2) from the top surface (72) of the primary packaging shell (7) in the vertical gap (g) between the contact surface (21) of the sealing head (22) and the top surface (72) of the primary packaging shell (7) when the primary packaging shell is supported by the shell support (3), such that upon relative movement of the shell support (3) and the sealing head (22) towards each other the sealing foil (81) is sealed to the top surface (72) of the primary packaging shell (7) along the sealing portion.

2. Sealing device (1) according to claim 1, wherein the shell support (3) comprises a support top surface (31) for supporting the primary packaging shell (7), and wherein the sealing head comprises a sealing rim (20) protruding downwardly and having the contact surface (21), the contact surface (21) facing the support top surface (31) of the shell support (3).

3. Sealing device according to claim 1, further comprising a force sensor (32) coupled to the shell support (3) for measuring a sealing force exerted by the sealing head (22) onto the shell support (3).

4. Sealing device according to claim 1, wherein the foil holder (4) is movable horizontally between a foil delivery position, in which the sealing foil (81) is held at the foil provision position, and a foil receiving position for placing the sealing foil (81) on the foil holder (4), the foil receiving position being horizontally displaced relative to the foil delivery position.

5. Sealing device according to claim 1, further comprising a foil gripper (5) for gripping the sealing foil (81) from a foil magazine (80) and placing it on the foil holder (4).

6. Sealing device according to claim 1, wherein the at least one linear actuator comprises a first linear actuator operatively coupled to the shell support (3), for performing a vertical movement of the shell support (3) towards and away from the sealing head (22), and a second linear actuator operatively coupled to the sealing head (22), for performing a vertical movement of the sealing head (22) towards and away from the shell support (3).

7. Sealing device according to claim 2, wherein the shell support (3) further comprises a hollow cylinder (30) having a circumferentially running cylinder wall (35), with a top surface of the circumferentially running cylinder wall (35) forming the support top surface (31) for supporting the primary packaging shell (7).

8. Sealing device according to claim 7, wherein the hollow cylinder (30) comprises a vacuum supply port for the supply of vacuum through an interior space of the hollow cylinder (30) to suck the primary packaging shell (7) against the top surface of the circumferentially running cylinder wall (35).

9. Sealing device according to claim 7, wherein the shell support (3) further comprises a ring (33) made of an elastic material, in particular silicone, which is arranged to form the top surface of the circumferentially running cylinder wall (35).

10. Sealing device according to claim 1, the sealing device configured for sealing a plurality of sealing foils (81) which are connected to one another to form a sealing foil strip (8) to the top surfaces (72) of a corresponding plurality of primary packaging shells (7), the sealing device comprising:
a plurality of said shell supports (3), each shell support (3) of the plurality of said shell supports for supporting one primary packaging shell (7) of the plurality of primary packaging shells (7);
a plurality of said sealing heads (22) corresponding to the plurality of said shell supports (3), each sealing head (22) of the plurality of said sealing heads having a said contact surface (21) facing towards one shell support (3) of the plurality of the said shell supports (3);
wherein the foil holder (4) is configured to hold each sealing foil (81) of the plurality of sealing foils of the sealing foil strip (8) in the respective foil provision position.

11. Sealing device according to claim 3, further comprising a plurality of said force sensors (32) corresponding to the plurality of said shell supports (3), each force sensor (32) of the plurality of said force sensors (32) coupled to a respective one shell support (3) of the plurality of said shell supports for measuring the individual sealing force exerted by the respective sealing head (22) of the plurality of sealing heads (22) onto the respective one shell support (3) of the plurality of shell supports (3) to which the respective force sensor (32) of the plurality of force sensors (32) is coupled.

12. Sealing device according to claim 1, further comprising at least one movable carrier (6) for transporting the primary packaging shell (7) or the plurality of primary packaging shells (7) and arranging the primary packaging shell (7) or the plurality of primary packaging shells (7) underneath the sealing head (22) or the plurality of sealing heads (22).

13. Sealing device according to claim 12, wherein the at least one movable carrier (6) comprises a carrier body (61) for carrying the primary packaging shell (7) and an opening (62) extending vertically through the carrier body (61), and wherein each shell support (3) is vertically movable upwards through the opening extending through the carrier body (61) to lift the primary packaging shell (7) from the movable carrier (6) so as to be supported by the respective shell support (3).

14. Method for sealing a sealing foil (81) onto a top surface (72) of a primary packaging shell (7) for an ophthalmic article such as an ophthalmic lens, in particular a contact lens such as a soft contact lens, the method comprising the steps of:
providing the primary packaging shell (7) on a shell support (3);
arranging the shell support (3) with the primary packaging shell (7) arranged thereon at a position vertically spaced from a heatable sealing head (22) and underneath the sealing head (22), the sealing head comprising a contact surface (21) protruding downwardly from the sealing head (22) towards a top surface (72) of the primary packaging shell (7) such that there is a vertical gap (g) between the contact surface (21) of the sealing head (22) and the top surface (72) of the primary packaging shell (7);
providing a sealing foil (81) at a foil provision position vertically spaced from the contact surface (21) of the sealing head (22) by a first predetermined distance (d1);
heating the sealing head (22) to a predetermined sealing temperature;
vertically moving the sealing head (22) and the shell support (3) with the primary packaging shell (7) arranged thereon relative to each other until the contact surface (21) of the sealing head (22) presses the sealing foil against the top surface (72) of the primary packaging shell (7) to seal the sealing foil (81) to the top surface (72) of the primary packaging shell (7) along a sealing portion defined by the contact surface (21) of the sealing head (22),
characterized in that the foil provision position of the sealing foil (81) is vertically spaced from the top surface (72) of the primary packaging shell (7) by a second predetermined distance (d2),
and in that vertically moving the sealing head (22) and the shell support (3) with the primary packaging shell (7) arranged thereon is performed such that the sealing foil (81) comes into contact with the top surface (72) of the primary packaging shell (7) and with the contact surface (21) of the sealing head (22) at the same time.

15. Method according to claim 1, wherein the method is performed using a sealing device (1).
